(19) United States
(12) Patent Application Publication
(10) Pub. No.: US 2013/0045631 A1
(43) Pub. Date: Feb. 21, 2013

(54) SOCKET CONNECTOR

(71) Applicant: CHIN-CHOU WANG, New Taipei (TW)

(72) Inventor: CHIN-CHOU WANG, New Taipei (TW)

(73) Assignee: Cheng Uei Precision Industry Co., LTD., New Taipei City (TW)

(21) Appl. No.: 13/211,251

(22) Filed: Aug. 16, 2011

(51) Int. Cl. H01R 24/28

(52) U.S. Cl. 439/626

(57) ABSTRACT

Disclosed is a socket connector, which includes an insulative body, conductive terminals, and a protective shell. A recess is defined in the insulative body. A plurality of terminal slots is defined in and perforated through four side walls of the insulative body. Each conductive terminal has a welding portion and an elastic contacting portion, in which the welding portion horizontally extends outside the side wall, and the elastic contacting portion extends to the recess. The protective shell is disposed around the insulative body. The welding portion is electrically coupled to an external circuit board. The lens module is inserted into the recess, thereby significantly reduces the height that the socket connector protrudes from the circuit board for reducing the vertical space usage of the socket connector.

### FIELD OF THE INVENTION

The present invention relates to an electrical connector, and especially to a compact and portable socket connector that is capable of reducing thickness of the lens module and the socket after assembly.

### BACKGROUND OF THE INVENTION

A camera has become an essential product for daily use. With development of technology, the camera is gradually developed to be more compact and portable.

However, thickness of a lens module and a socket after assembly is large in an existing camera, such that it is disadvantageous to the overall assembly of the camera having large space occupancy, which hinders the development of a compact and portable camera.

As to the above-mentioned drawback, there is an urgent need to propose a compact and portable socket connector that is capable of reducing thickness of the lens module and the socket after assembly.

### SUMMARY OF THE INVENTION

An objective of the present invention is to provide a compact and portable socket connector that is capable of reducing thickness of the lens module and the socket after assembly in accordance with the drawback of the above-mentioned prior art.

To achieve the foregoing objectives, the present invention provides a socket connector which is used for mounting a lens module. The socket connector includes an insulative body, conductive terminals, and a protective shell. The insulative body is square, and a recess is defined in the insulative body. A pickup region is disposed at a bottom of the recess. A plurality of terminal slots is defined in and perforated through four side walls of the insulative body. Bottom ends of the terminal slots extend and bend toward a bottom wall of the insulative body. The conductive terminals are disposed in the terminal slots and inserted from outside to inside. Each conductive terminal has a welding portion and an elastic contacting portion, in which the welding portion horizontally extends outside the side wall, and the elastic contacting portion extends to the recess. The protective shell is disposed around the insulative body.

As mentioned above, the welding portion of the socket connector of the present invention is electrically coupled to an external circuit board. The recess is defined in the socket connector, and the lens module is inserted into the recess, thereby significantly reduces the height that the socket connector protrudes from the circuit board for reducing the vertical space usage of the socket connector.

### BRIEF DESCRIPTION OF THE DRAWINGS

FIG. 1 is a perspective view illustrating an electronic lens according to the present invention;

FIG. 2 is an exploded view illustrating the electronic lens according to the present invention;

FIG. 3 is an exploded view illustrating a socket connector of the electronic lens according to the present invention; and

FIG. 4 is a schematic drawing illustrating the socket connector of the electronic lens coupling to the circuit board.

### DETAILED DESCRIPTION OF THE PREFERRED EMBODIMENTS

Reference will now be made in detail to the present preferred embodiment of the invention, example of which is illustrated in the accompanying drawings.

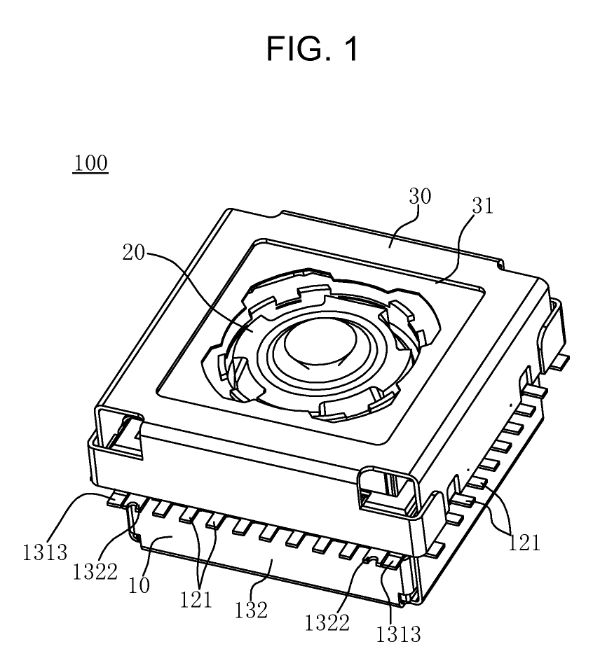

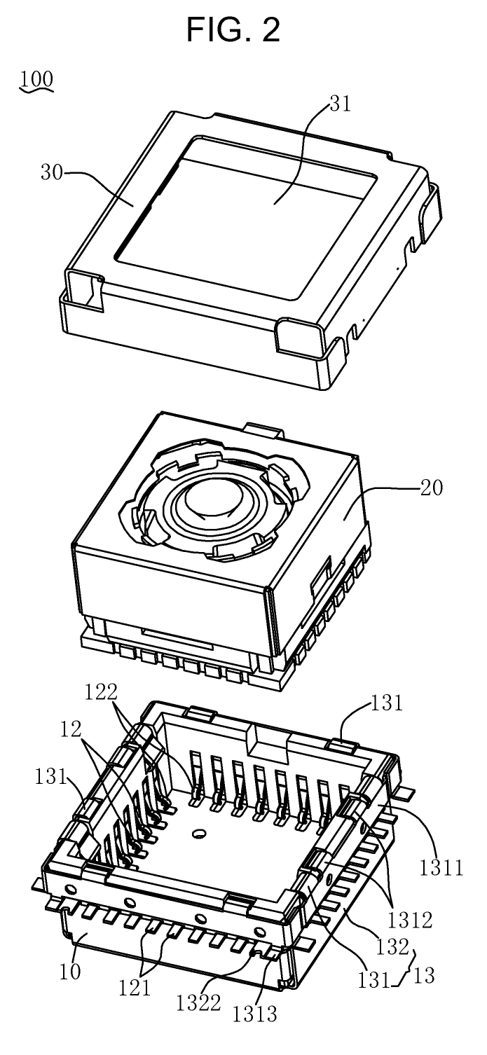

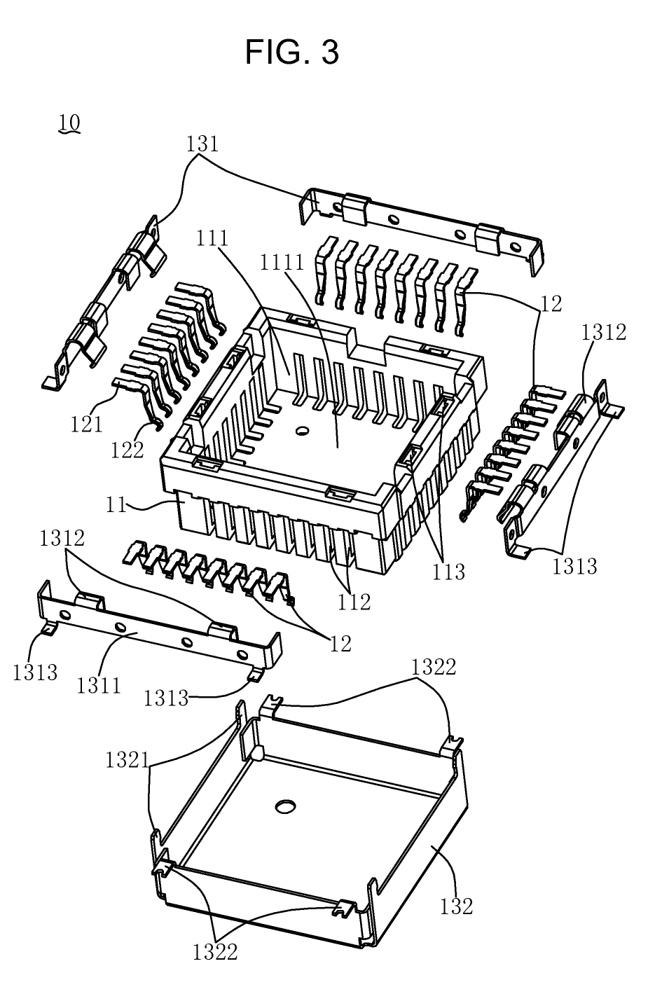

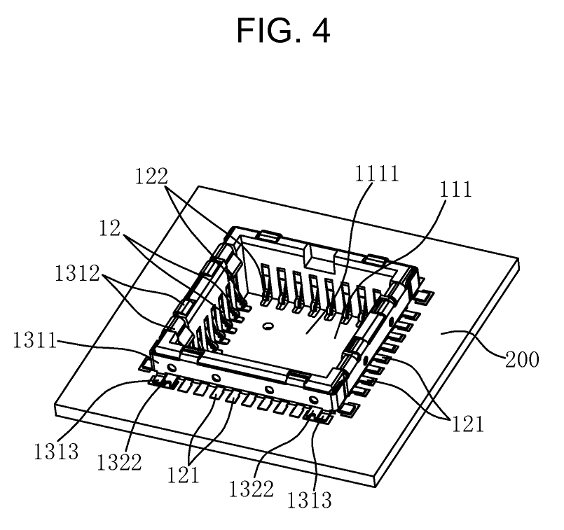

Referring to FIG. 1 to FIG. 4, an electronic lens 100 includes a socket connector 10, a lens module 20, and shell 30, according to the present invention.

The socket connector 10 is electrically coupled to the circuit board 200. The socket connector 10 includes an insulative body 11, conductive terminals 12, and a protective shell 13. The insulative body 11 is square, and a recess 111 is defined in the insulative body 11. A pickup region 1111 is disposed at a bottom of the recess 111 for collecting image signals. A plurality of terminal slots 112 is defined in and perforated through four side walls of the insulative body 11. Bottom ends of the terminal slots 112 extend and bend toward a bottom wall of the insulative body 11. Fixing slots 113 corresponding to top protective shells 1312 are defined on the top of the insulative body 11.

The conductive terminals 12 are disposed in the terminal slots 112 and inserted from outside to inside. Each conductive terminal 12 has a welding portion 121 and an elastic contacting portion 122. The welding portion 121 herein horizontally extends outside the side wall, and the elastic contacting portion 122 extends to the recess 111.

The protective shell 13 includes four upper protective shells and a lower protective shell 132. The upper protective shells 131 respectively are disposed on upper ends of the four side walls of the insulative body 11. Specifically, the upper protective shell 131 includes a side-wall protective shell 1311 for protecting an upper end of the side wall of the insulative body 11 and includes a top protective shell 1312 for protecting a top of the insulative body 11. The top protective shell 1312 inwardly extends from an upper end of the side wall protective shell 1311, and the top protective shell 1312 is engaged with the fixing slot 113. Two first connecting ends 1313 extend from two sides of a lower end of the side-wall protective shell 1311. Inserting flakes 1321 extend upwards from upper ends of two opposite side walls of the lower protective shell 131. Slots (not shown) which correspond to the inserting flakes 1321 are defined in the insulative body 11. The inserting flakes 1321 are inserted into the slots, thereby making the lower protective shell 132 engage with the lower end of the insulative body 11. The second connecting ends 1322 respectively extend form both sides of upper ends of the other two opposite side walls of the lower protective shell. The first connecting ends 1313 and the second connecting ends 1322 are located on a same plane of the welding portions 121. The first and second connecting ends that correspond to a same side wall of the insulative body 11 are electrically coupled to a same contact on the circuit board 200. Thus, the entire protective shell 13 is grounded, so that an anti-electromagnetic interference effect is formed around the protective shell 13.

The lens module 20 is disposed in the recess 111, and the image signals are collected by the pickup region 1111 after passing through the lens module 10.

An opening 31 is defined in the shell 30, and the shell 30 covers the lens module and engages with the protective shell 13, in which the lens module 20 protrudes from the opening 31.

As mentioned above, the welding portion 121 of the socket connector 10 of the present invention is electrically coupled to an external circuit board 200. The recess 111 is defined in the socket connector 10, and the lens module 20 is inserted into the recess 111, thereby significantly reducing the height that the socket connector 10 protrudes from the circuit board 200 for reducing the vertical space usage of the socket connector 10.

While the preferred embodiments of the present invention have been illustrated and described in detail, various modifications and alterations can be made by persons skilled in this art. The embodiment of the present invention is therefore described in an illustrative but not restrictive sense.

What is claimed is:

1. A socket connector electrically coupled to a circuit board for mounting a lens module, comprising:
an insulative body being square, a recess defined in the insulative body, a pickup region disposed at a bottom of the recess, a plurality of terminal slots defining in and perforating four side walls of the insulative body, the terminal slots having bottom ends extending and bending toward a bottom wall of the insulative body;
a plurality of conductive terminals disposed in the terminal slots and inserted from outside to inside, each conductive terminal having a welding portion and an elastic contacting portion, wherein the welding portion horizontally extends outside the side wall, and the elastic contacting portion extends to the recess; and
a protective shell disposed around the insulative body.

2. The socket connector of claim 1, wherein the protective shell comprises four upper protective shells and a lower protective shell, and the upper protective shells respectively are disposed around upper ends of the four side walls of the insulative body, and the lower protective shell is disposed around a bottom of the insulative body, and wherein first connecting ends and second connecting ends respectively extend form both sides of the upper protective shell and the lower protective shell corresponding to a same side wall of the insulative body, further the first and second connecting ends being electrically coupled to a same contact are located on a same plane of the welding portions.

3. The socket connector of claim 2, wherein the upper protective shell comprises a side-wall protective shell for protecting an upper end of the side wall of the insulative body and a top protective shell for protecting a top of the insulative body, and wherein the top protective shell inwardly extends from an upper end of the side wall protective shell, and wherein the top protective shell having a corresponding fixing slot thereto being defined on the top of the insulative body, and the top protective shell is engaged with the fixing slot.

4. The socket connector of claim 1, further comprising a shell, an opening defined in the shell, the shell covering the lens module and engaging the protective shell, wherein the lens module protrudes from the opening.
